(19) United States
(12) Patent Application Publication
(10) Pub. No.: US 2016/0104208 A1
(43) Pub. Date: Apr. 14, 2016

(54) AD SLOT OWNERSHIP FOR PERSISTENT CREATIVES

(71) Applicant: LiveIntent, Inc., New York, NY (US)

(72) Inventors: Matthew Rosenbach Keiser, New York, NY (US); Jerome Charles Sandoval, New York, NY (US)

(21) Appl. No.: 14/874,122

(22) Filed: Oct. 2, 2015

Related U.S. Application Data
(60) Provisional application No. 62/062,064, filed on Oct. 9, 2014.

(51) Int. Cl. G06Q 30/02

(52) U.S. Cl. CPC G06Q 30/0275; G06Q 30/0241

(57) ABSTRACT

An ad slot ownership module receives, from a user agent, a call requesting a creative for a first slot of a plurality of slots in an email and determines whether an ownership period associated with the first slot has expired. When the ownership period associated with the first slot has not expired, the ad slot ownership module selects a creative from a campaign associated with an advertiser that owns the first slot for the ownership period and serves the selected creative for the first slot to the user agent.

### RELATED APPLICATIONS

This application claims the benefit of U.S. Provisional Application 62/062,064, filed Oct. 9, 2014, the entire contents of which are hereby incorporated by reference herein.

### TECHNICAL FIELD

This disclosure relates to the field of on-line advertising, including customer relationship management, marketing automation and lead management, and, in particular, to ad slot ownership for persistent creatives.

### BACKGROUND

Much on-line media content is offered to users free of charge and subsidized through on-line advertising. On-line advertising can include advertising messages conveyed using text, logos, animations, videos, photographs or other graphics. Some examples of on-line advertisements include web banners, email messages, frame ads, pop-up ads, floating ads, expanding ads, trick banners, interstitial ads, and text ads. These on-line advertisements can be presented to a user in a variety of ways including on a web-page, through email, through social media applications, or on a mobile device.

### BRIEF DESCRIPTION OF THE DRAWINGS

The present disclosure is illustrated by way of example, and not by way of limitation, in the figures of the accompanying drawings.

FIG. 1 is a block diagram illustrating an exemplary network architecture in which embodiments of the present disclosure may be implemented.

FIG. 2 is a block diagram illustrating an ad slot ownership module, according to some embodiments.

FIG. 3 is a flow diagram illustrating a method for ad slot ownership processing, according to some embodiments.

FIG. 4 is a flow diagram illustrating a method for ad slot ownership processing, according to some embodiments.

FIG. 5 is a block diagram illustrating an exemplary computer system, according to some embodiments.

### DETAILED DESCRIPTION

Embodiments are described for ad slot ownership for persistent creatives where an ad slot for a user is dedicated to an advertiser over time, and the served creatives are optimized during that dedicated time period to maximize performance for the advertiser. In one embodiment, an ad slot ownership module in a server can receive a request from a user agent for a creative to fill a slot in a template associated with piece of content provided by a publisher. The content may include, for example, a web page, an email or some other piece of content. The template may include multiple slots where an advertisement or other piece of content can be displayed or linked to. In one embodiment, in response to receiving the request for a creative for one ad slot (e.g., a first ad slot, which may be any ad slot in the template), the ad slot ownership module can determine whether the ad slot is currently owned (dedicated for a time period) by a given advertiser. In one embodiment, advertisers can bid on exclusive rights to an ad slot for a set period of time (e.g., two weeks, one month, 90 days). If there is a current owner of the ad slot, and the ownership period has not expired, the ad slot ownership module can perform an optimization to select a creative from an advertisement campaign of the current advertiser to display in the ad slot in response to the request for the creative. Creatives from the same campaign may be displayed in the ad slot for the duration of the ownership period.

If the ad slot is not currently owned or the ownership period has expired, the ad slot ownership module may generate bid requests for the ad slot. The ad slot ownership module can conduct an auction among advertisers and receive bid responses from the advertisers. The bid responses may include a price that each advertiser is willing to pay to have their creatives (e.g., advertisement, marketing message, content) displayed in a particular slot, a period of time for which the advertiser is willing to buy the ad slot or a value, which may include any way to rank the importance or engagement of having creatives appear in the particular slot. The ad slot ownership module can perform an optimization process to determine a bid, or combination of bids, that will result in a highest payout (yield, conversion rate, click rate, etc.) to the publisher for the ad slot, or for the entire template. The ad slot ownership module can then serve the appropriate creative(s) over the time period to the user agent for display with the content.

By purchasing or otherwise reserving an ad slot for a period of time, an advertiser can guarantee that a creative from their campaign will be displayed each time the email is opened during the ownership period. This prevents the advertiser from having to enter an auction each time a creative is requested for the particular ad slot. In addition, by selling the ad slot for a period of time, the publisher need not conduct a new auction each time, which may save some overhead costs. In one embodiment, the advertiser may pay a premium for purchasing the ad slot for the entire ownership period. This can result in increased yield for the publisher. In another embodiment, the advertiser may be offered a discount for purchasing the ad slot for the entire ownership period. This can result in a savings in advertising costs for the advertiser. In another embodiment, the advertiser may optimize the display of multiple creatives over the ownership time period in a manner to maximize the desired result, e.g., registration or conversion.

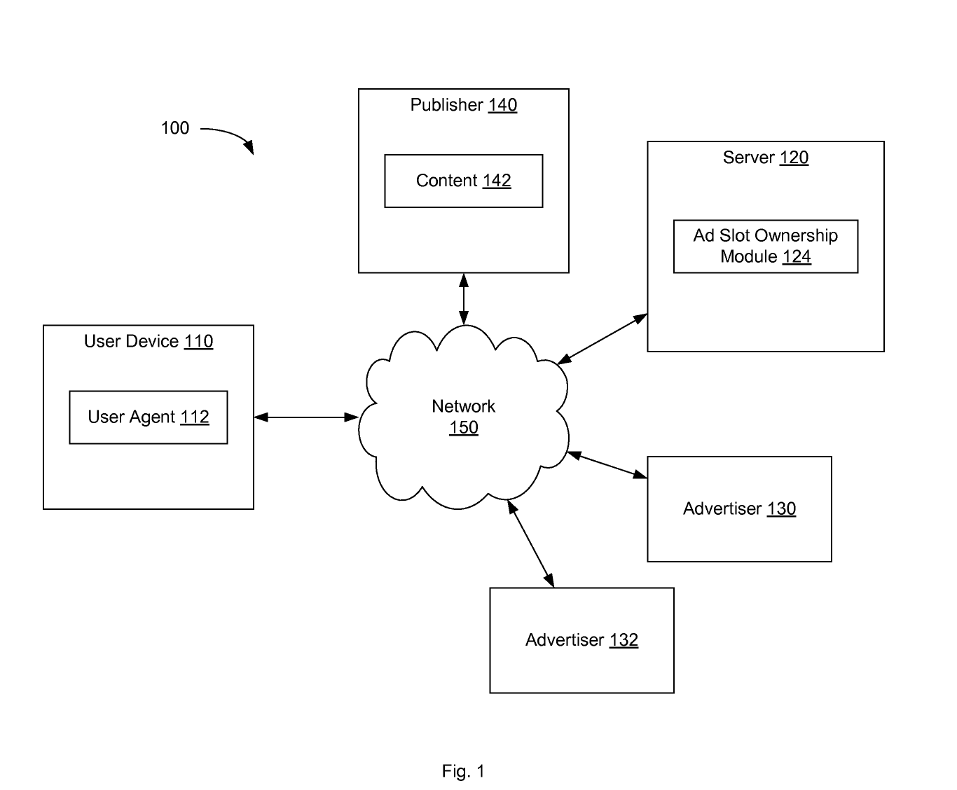

FIG. 1 is a block diagram illustrating an exemplary network architecture in which embodiments of the present disclosure may be implemented. The network architecture 100 can include one or more user devices 110 communicating with one or more servers, such as server 120 over one or more networks 150, according to one embodiment. Network 150 can be a local area network (LAN), a wireless network, a telephone network, a mobile communications network, a wide area network (WAN), such as the Internet, or similar communication system. User device 110 may be any type of computing device including a desktop computer, laptop computer, mobile communications device, cell phone, smart phone, hand-held computer, tablet computer, or similar computing device. User device 110 may be variously configured with different features to enable viewing of multimedia content, such as images, videos, songs, etc., webpages, email, or other content.

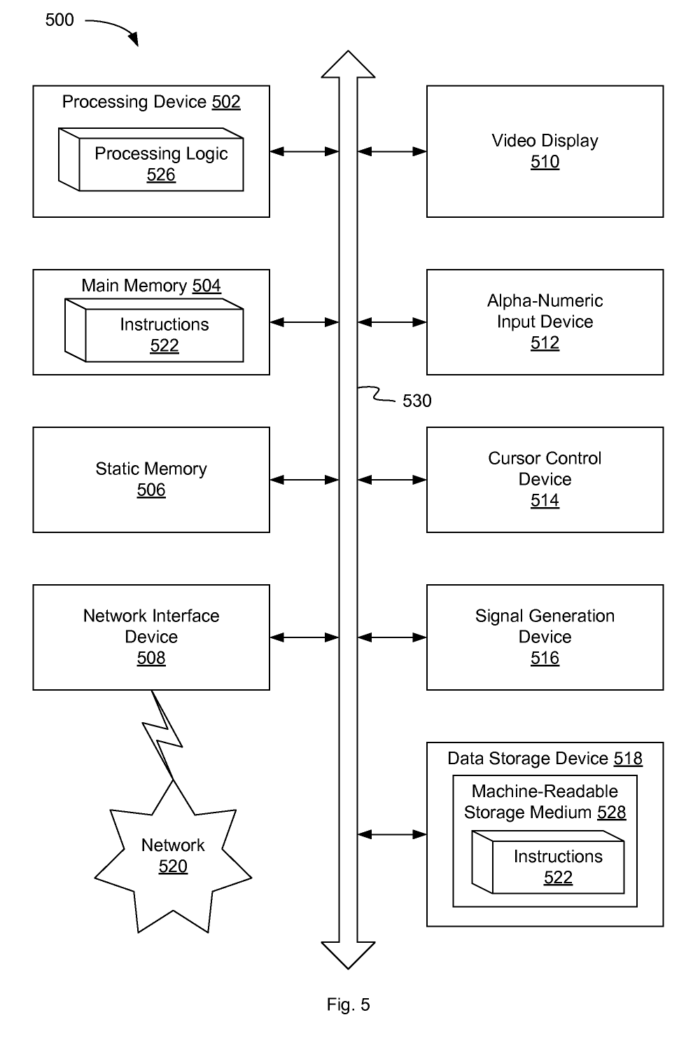

Server 120 may include a network-accessible server-based functionality, various data stores, and/or other data processing equipment. Server 120 may be implemented by a single machine or a cluster of machines. Server 120 may be hosted, for example, by computer system 500 of FIG. 5. In one embodiment, server 120 is an advertising server that stores advertisements used in online marketing campaigns and delivers them to users. In another embodiment, server 120 is some other server that facilitates communication between user device 110, publisher 140, advertisers 130, 132 and/or some other advertising server.

For example, a user of user device 110 can view a web page or email sent by server 120 or publisher 140, using a web browser, email client application or other program running on user device 110. Collectively, the programs used to view content on user device 120 may be referred to as user agent 112. Publisher 140 can deliver web pages to user device 110 or another client device using for example the Hypertext Transfer Protocol (HTTP). In another embodiment, publisher 140 may be an email server that delivers emails to user device 110. In another embodiment, publisher 140 may instruct some other server to serve web pages or send emails to user device 110.

In one embodiment, server 120 also includes ad slot ownership module 124. Ad slot ownership module 124 can receive a request from user agent 112 for a creative to fill an advertisement slot in an advertisement template associated with piece of content 142 provided by publisher 140. The content 142 may include, for example, a web page, an email or some other piece of content. The template may include multiple slots where an advertisement or other piece of content can be displayed or linked to. In one embodiment, in response to receiving the request for a creative for one ad slot (e.g., a first ad slot, which may be any ad slot in the template), ad slot ownership module 124 can determine whether the ad slot is currently owned by a given advertiser. In one embodiment, advertisers can bid on exclusive rights to a certain ad slot for a set period of time (e.g., two weeks, one month, 90 days). If there is a current owner of the ad slot, and the ownership period has not expired, the ad slot ownership module can perform an optimization to select a creative from an advertisement campaign of the current advertiser to display in the ad slot in response to the request for the creative. This optimization may optimize the overall ad performance during the time period, and may also provide a more personalized experience for the user. Creatives from the same campaign may be displayed in the ad slot for the duration of the ownership period.

If the ad slot is not currently owned or the ownership period has expired, the ad slot ownership module 124 may generate bid requests for the ad slot. Ad slot ownership module 124 can conduct an auction among advertisers 130 and 132 and receive bid responses from the advertisers 130 and 132. The bid responses may include a price that each advertiser is willing to pay to have their creative (e.g., advertisement) displayed in a particular ad slot and/or a period of time for which the advertiser is willing to buy or reserve the ad slot. Ad slot ownership module 124 can perform a yield optimization process to determine a bid or a combination of bids that will result in a highest payout (yield, conversion rate, etc.) to the publisher 140 for the template. Ad slot ownership module 124 can then serve the appropriate creative to user agent 112 for display with the content 142. In other embodiments, ad slot ownership module 124 can run on some other server, or on some other separate computing device. In another embodiment, ad slot ownership module 124 can instruct some other advertisement server to serve the appropriate creative to user agent 112. Some embodiments of ad slot ownership module 124 are discussed in more detail below.

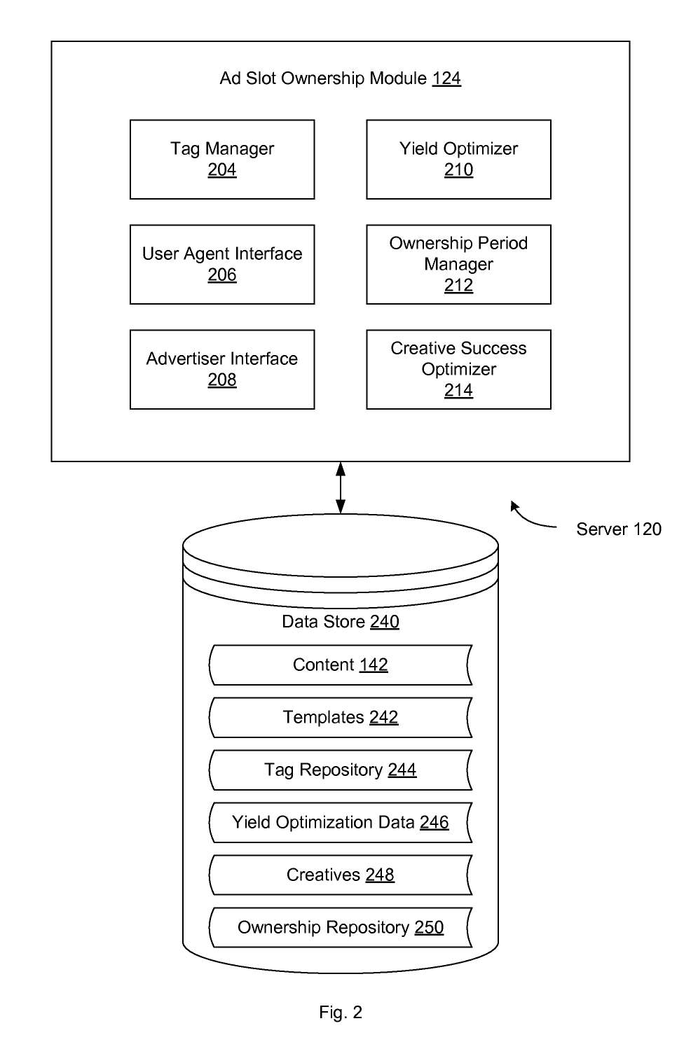

FIG. 2 is a block diagram illustrating ad slot ownership module 124, according to some embodiments of the present disclosure. In one embodiment, ad slot ownership module 124 includes tag manager 204, user agent interface 206, advertiser interface 208, yield optimizer 210, ownership period manager 212 and creative success optimizer 214. This arrangement of modules may be a logical separation, and in other embodiments, these modules or other components can be combined together or separated in further components, according to a particular embodiment. In one embodiment, storage device 240 is connected to ad slot ownership module 124 and includes content 142, templates 242, tag repository 244, yield optimization data 246, creatives 248 and ownership repository 250. In one embodiment, server 120 may include ad slot ownership module 124 and storage device 240. In another embodiment, storage device 240 may be external to server 120 and may be connected to server 120 over a network or other connection. In other embodiments, server 120 may include different and/or additional components which are not shown to simplify the description. Storage device 240 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, tag manager 204 assigns tags to each of the ad slots in a template. The tags may uniquely identify each ad slot and associate each ad slot with a template 242. The template 242 defines the number, location, size, etc. of ad slots in the template. In this manner, an individual ad slot can be identified as part of a given template and the additional ad slots associated with the template can also be identified. In one embodiment, a tag may include a set number of binary bits or bytes. In other embodiments, a tag may include human readable text, numbers, symbols or other characters.

In one embodiment, user agent interface 206 detects that a piece of content 142 (e.g., an email, webpage) including an advertisement template 242 is sent to a user agent 112 on user device 110. The email itself may be sent by publisher 140 or some other email server, rather than ad slot ownership module 124. User agent interface 206 may receive an ad call from the user agent 112 requesting a creative for a first ad slot of the multiple ad slots in the template 242. In response, user agent interface 206 can notify tag manager 204, which in turn can identify the remaining ad slots in template 242 based on the tag. In one embodiment, tag repository 244 may include a listing of each template and the associated ad slots. Alternatively, the tag itself may identify one of templates 242.

In one embodiment, advertiser interface 208 generates a bid request for the first advertisement slot in the template. In other embodiments, advertiser interface 208 generates bid requests for each of the advertisement slots in the template, even though an ad call for only one ad slot has been received. Advertiser interface 208 may send the bid requests to advertisers 130 and 132, thereby initiating an auction for the multiple ad slots in the template. In one embodiment, the bid requests may specify a period of time for which the advertiser can purchase the ad slot. If their bid is accepted, the advertiser would be able to have their creatives displayed in the ad slot for the entire period of time for which they purchased the ad slot. In response to the bid requests, advertiser interface 208 may receive responses to the bid requests including prices the advertisers 130 and 132 are willing to pay for each ad slot, how may ad slots they wish to purchase, how long they are willing to purchase the ad slot for, etc. The prices may be defined on a cost per mille (CPM) basis, calculated using a click-through rate, a conversional goal, or some other metric. Additional value in the optimization calculation may also be derived by the purchase of multiple slots which may result in higher yield for the publisher and/or larger discounts for the advertisers.

In one embodiment, yield optimizer 210 performs a yield optimization based on the responses to the bid requests to determine creatives 248 for each of the ad slots in the template that will maximize a payout to the publisher 140 for the template. In one embodiment, the yield may be affected by such factors as the price an advertiser is willing to pay, how many ad slots an advertiser is willing to purchase, how many advertisers are willing to purchase a given slot, the basis on which the cost is defined, how long an advertiser is willing to purchase the ad slot for, or other factors. In one embodiment, the yield optimization may be performed on an ad slot by ad slot basis, providing the best individual yield for one or more ad slots. In another embodiment, the yield optimization may be performed across multiple ad slots within a template, taking into account allowed interactions between ad slots (e.g., advertiser A may not want a competitive advertiser B showing ads in the same email, or advertiser A may require multiple ad slots to improve their message and potential outcomes). In one embodiment, the yield optimization may set goals and constraints to maximize payout to the publisher of the template. In another embodiment, the yield optimization may set goals and constraints to achieve other goals such as improved personalization for the end user or higher likelihood of performance-based results (e.g., conversion goals) for the advertiser. Improved personalization or higher performance are indirect means of increasing long term yield for the publisher as advertisers are likely to continue purchases over time. Yield optimizer 210 may perform calculations based on these factors and store the results as yield optimization data 246. Yield optimizer 210 may include mathematical optimizations using linear programming, or may include heuristic adaptations to address real time optimization needs. Based on the yield optimization, user agent interface 206 may select creatives 248 provided by advertisers 130 and 132 and serve those creatives 248 to user agent 112 to be displayed in the designated ad slots of the template 242 associated with the piece of content 142 provided by publisher 140. As the advertisers 130 and 132 and creatives 248 are selected for designated ad slots of template 242, the ownership period manager 212 starts to track the ownership period for each advertiser and ad slot in the ownership repository 250.

In one embodiment, ownership period manager 212 keeps track of and enforces ad slot ownership by advertisers. In one embodiment, when user agent interface 206 receives an ad call for a certain ad slot, ownership period manager 212 determines whether the ad slot is currently owned and whether a previous ownership period has expired. Ownership period manager 212 may identify the ad slot using data from tag repository 244 and may cross reference the ad slot with ownership information in ownership repository 250. In one embodiment, tag repository 244 and ownership repository 250 are part of the same data structure, such that only one data access operation is required. In addition, when an ad slot is newly purchased at auction, ownership period manager 212 determines the ownership period from advertiser interface 208 and stores an indication of that ownership period in ownership repository 250.

Once the advertiser owner for an ad slot has been determined, the creative success optimizer 214 manages the selection of which creative to serve into the ad slot. In one embodiment, this selection process is performed for an individual ad slot to provide the best advertiser business result for a slot. In another embodiment, the selection process is performed across multiple slots in the template to provide the best advertiser business result across the multiple slots owned by the advertiser. In one embodiment, creative success optimizer 214 manages selection of a particular creative from an advertising campaign associated with an advertiser who purchased an ad slot for a set period of time. In one embodiment, creative success optimizer 214 selects a creative from the campaign that is most likely to produce the desired business result such as user view, click, or conversion. The desired business result may be measured in a variety of ways such as click-through-rate, likelihood of conversions, or via some other business result metric determined by ad slot ownership module 124 or by the advertiser. In one embodiment, creative success optimizer 214 groups similar creatives together according to certain factors, such as subject matter, length, visual style, etc., and obtains information about the success of the same or other similar creatives in the group. This can be used in combination with certain attributes of the targeted consumer, such as location, time of day, browser type, gender, age, income, etc. to determine which creative has the highest likelihood of success in the desired business result. In one embodiment, creative success optimizer 214 also enforces a set of rules associated with a campaign when selecting the creative for a given ad slot, time period, and user. The advertiser or publisher may define a set of rules to follow when selecting a creative. For example, the rules might specify certain creatives that are to be served (or not served) at certain times, in certain locations, to certain types of devices, to specific individuals, to certain categories of individuals, etc. The rules might also specify intra-creative selection attributes such as creatives that should be served together, or creatives that should not be served together. The rules might also extend to include external creative selection mechanisms such as a recommendation engine that might provide a new creative based on previous user interactions with the advertiser, e.g., if the user has taken action on ads for London travel, also show the user ads for Paris travel. In one embodiment, the success of the desired business result for creative selection is based on one or more ad slots within the template. In another embodiment, the success of the desired business result for creative selection is based on a longer term valuation that measures the success of guiding a user through a marketing funnel to a desired conversion.

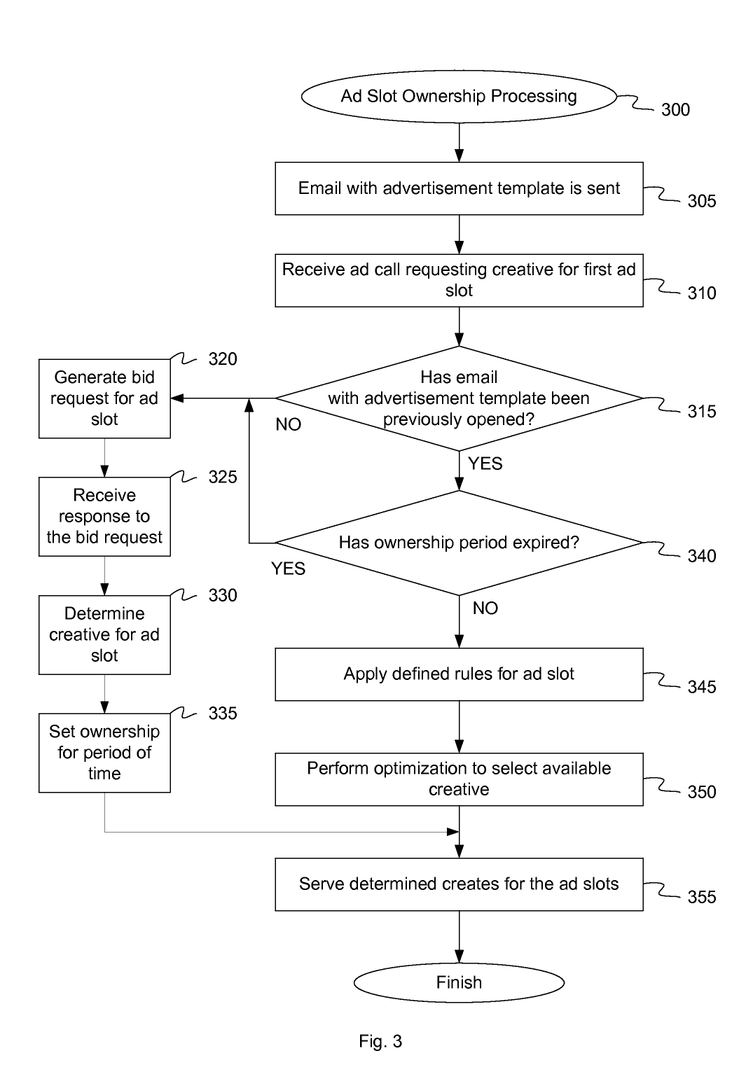

FIG. 3 is a flow diagram illustrating a method for ad slot ownership processing, according to some embodiments. The method 300 may be performed by processing logic that comprises hardware (e.g., circuitry, dedicated logic, programmable logic, microcode, etc.), software (e.g., instructions run on a processing device to perform hardware simulation), or a combination thereof. The method 300 can determine whether a particular ad slot has been purchased by an advertiser for a period of time and optimize which creative will be the most successful during that period. In one embodiment, method 300 may be performed by ad slot ownership module 124, as shown in FIGS. 1 and 2.

Referring to FIG. 3, at block 305, an email with an advertisement template is sent. In one embodiment, publisher 140 sends a piece of content 142 (e.g., an email, webpage) including an advertisement template 242 to a user agent 112 on user device 110. In one embodiment, ad slot ownership module 124 instructs publisher 140 on which template 242 to include in the email or is at least made aware of which template 242 was included.

At block 310, method 300 receives an ad call requesting a creative for a first ad slot in the template 242. User agent interface 206 may receive an ad call from the user agent 112 requesting a creative for a first ad slot of the multiple ad slots in the template 242. In response, user agent interface 206 can notify tag manager 204, which in turn can identify the remaining ad slots in template 242 based on the tag. In one embodiment, tag repository 244 may include a listing of each template and the associated ad slots. Alternatively, the tag itself may identify one of templates 242.

At block 315, method 300 determines whether the email with the advertisement template 242 has been previously opened by the user agent 112 or by any other user agent that also received the email. Tag manager 204 may maintain records in tag repository 244 indicating whether or not a creative has been served to a particular user agent 112 or a group of user agents for a particular piece of content 142, with a particular template 242, for a particular ad slot. Tag manager 204 can consult these records to make the determination.

If the email has not been previously opened by any user agent, at block 320, method 300 generates bid requests for each of the ad slots in the template. In one embodiment, advertiser interface 208 generates a bid request for an advertisement slot in the template. In other embodiments, advertiser interface 208 generates bid requests for each of the advertisement slots in the template, even though an ad call for only one ad slot has been received. Advertiser interface 208 may send the bid requests to advertisers 130 and 132, thereby initiating an auction for the multiple ad slots in the template. In one embodiment, the bid requests may specify a period of time for which the advertiser can purchase or reserve the ad slot. If their bid is accepted, the advertiser would be able to have their creatives displayed in the ad slot for the entire period of time for which they purchased or reserved the ad slot.

At block 325, method 300 receives responses to the bid requests from advertisers 130 and 132. In response to the bid requests, advertiser interface 208 may receive responses to the bid requests including prices the advertisers 130 and 132 are willing to pay for each ad slot, how may ad slots they wish to purchase, etc. The prices may be defined on a cost per mille (CPM) basis, calculated using a click-through rate, a conversional goal, or some other metric. In one embodiment, the responses to the bid requests may include a period of time for which the advertiser wishes to purchase or reserve the ad slot. This period of time may be the same or different (e.g., longer or shorter) than the period specified in the bid request. In one embodiment, if the bid request did not specify a period of time, the period in the response may be of any length determined by the advertiser.

At block 330, method 300 performs yield optimization based on the responses to determine a combination of creatives for the ad slots that will maximize a payout to the publisher 140 for the advertisement template. In one embodiment, yield optimizer 210 performs a yield optimization based on the responses to the bid requests to determine creatives 248 for each of the ad slots in the template that will maximize a payout to the publisher 140 for the template. In one embodiment, the yield may be affected by such factors as the price an advertiser is willing to pay, how many ad slots an advertiser is willing to purchase, how many advertisers are willing to purchase a given slot, the basis on which the cost is defined, the period of time for which the advertiser is willing to purchase the ad slot or other factors. Yield optimizer 210 may perform calculations based on these factors and store the results as yield optimization data 246.

At block 335, method 300 sets the ownership of the ad slot for the period of time based on the yield optimization. In one embodiment, when an ad slot is newly purchased at auction, ownership period manager 212 determines the ownership period from advertiser interface 208 and stores an indication of that ownership period in ownership repository 250.

At block 355, method 300 serves the determined creatives for the ad slots. Based on the yield optimization, user agent interface 206 may select creatives 248 provided by advertisers 130 and 132 and serve those creatives 248 to user agent 112 to be displayed in the designated ad slots of the template 242 associated with the piece of content 142 provided by publisher 140. In another embodiment, user agent interface 206 instructs some other advertising server to serve creatives 248.

If method 300 determines at block 315 that the email has been previously opened by user agent 112 or by some other user agent, at block 340, method 300 determines whether a current ownership period has expired. In one embodiment, when user agent interface 206 receives an ad call for a certain ad slot, ownership period manager 212 determines whether the ad slot is currently owned and whether a previous ownership period has expired. Ownership period manager 212 may identify the ad slot using tag from tag repository 244 and may cross reference the ad slot with ownership information in ownership repository 250. If the current ownership period has expired, method 300 continues to block 320.

If the current ownership period has not expired, at block 345, method 300 applies any defined rules for the ad slot. In one embodiment, creative success optimizer 214 enforces a number of rules and constraints associated with a campaign when selecting the creative for a given ad slot. The advertiser or publisher may define certain rules to follow when selecting a creative. For example, the rules might specify certain creatives that are to be served (or not served) at certain times, in certain locations, to certain types of devices, to specific individuals, to certain categories of individuals, etc.

At block 350, method 300 performs an optimization to select an available creative to be served. In one embodiment, creative success optimizer 214 selects a creative from the campaign that is most likely to be successful. Success may be measured in a variety of ways such as click-through-rate, likelihood of conversions, or via some other metric determined by ad slot ownership module 124 or by the advertiser. In one embodiment, creative success optimizer 214 groups like creatives together according to certain factors, such as subject matter, length, visual style, etc., and obtains information about the success of the same or other similar creatives in the group. This can be used in combination with certain attributes of the consumer, such as location, time of day, browser type, gender, age, income, etc. to determine which creative has the highest likelihood of success.

At block 355, method 300 serves the determined creatives for the ad slots. User agent interface 206 may serve the identified creative to user agent 112 for display in the template with the content.

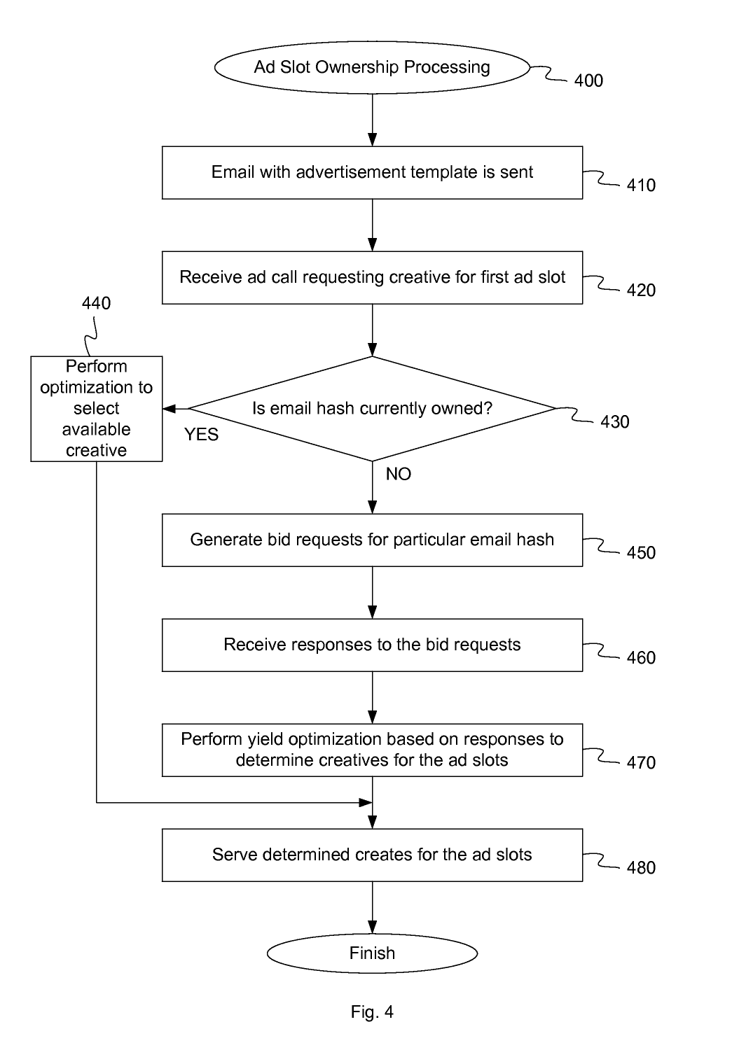

FIG. 4 is a flow diagram illustrating a method for ad slot ownership processing, according to some embodiments. The method 400 may be performed by processing logic that comprises hardware (e.g., circuitry, dedicated logic, programmable logic, microcode, etc.), software (e.g., instructions run on a processing device to perform hardware simulation), or a combination thereof. The method 400 can determine whether a particular ad slot has been purchased by an advertiser for a period of time and optimize which creative will be the most successful during that period. In one embodiment, method 400 may be performed by ad slot ownership module 124, as shown in FIGS. 1 and 2.

Referring to FIG. 4, at block 410, an email with an advertisement template is sent. In one embodiment, publisher 140 sends a piece of content 142 (e.g., an email, webpage) including an advertisement template 242 to a user agent 112 on user device 110. In one embodiment, ad slot ownership module 124 instructs publisher 140 on which template 242 to include in the email or is at least made aware of which template 242 was included.

At block 420, method 400 receives an ad call requesting a creative for a first ad slot in the template 242. User agent interface 206 may receive an ad call from the user agent 112 requesting a creative for a first ad slot of the multiple ad slots in the template 242. In response, user agent interface 206 can notify tag manager 204, which in turn can identify the remaining ad slots in template 242 based on the tag. In one embodiment, tag repository 244 may include a listing of each template and the associated ad slots. Alternatively, the tag itself may identify one of templates 242.

At block 430, method 300 determines whether a unique identifier associated with the recipient of the email is currently owned or reserved. The unique identifier may include, for example, an ad ID, a universal cross-channel identifier, a hash of the recipient's email address or some other identifier. In one embodiment, when user agent interface 206 receives an ad call for a certain ad slot, ownership period manager 212 determines whether the unique identifier associated with the recipient and received with ad call is currently owned or reserved for some portion of time. In one embodiment, an advertiser may purchase a particular email hash, or a group of email hashes, to which they have the exclusive rights to display advertisements, for a specific period of time. In one embodiment, the email hash is a value computed using a cryptographic function that represents a particular email address. The email hash preserves the privacy of the consumer's actual email address, while providing the ability to target messages to the consumer including advertising, content, etc. Ownership period manager 212 may identify the email hash or other unique identifier from the ad call and may cross reference the hash with hash ownership information in ownership repository 250.

If the email hash is currently owned, at block 440, method 400 performs an optimization to select an available for creative to be served. In one embodiment, creative success optimizer 214 selects a creative from the campaign that is most likely to be successful for the specific consumer associated with the email hash. Success may be measured in a variety of ways such as click-through-rate, likelihood of conversions, or via some other metric determined by ad slot ownership module 124 or by the advertiser. In one embodiment, creative success optimizer 214 groups like creatives together according to certain factors, such as subject matter, length, visual style, etc., and obtains information about the success of the same or other similar creatives in the group. This can be used in combination with certain attributes of the consumer, such as location, time of day, browser type, gender, age, income, etc. to determine which creative has the highest likelihood of success. These attributes may be obtained from the publisher, from the advertiser, from the consumer directly, or from a third-party source.

If the email hash is not currently owned, at block 450, method 400 generates bid requests for an ad slot specific to the particular email hash. Advertiser interface 208 may send the bid request to advertisers 130 and 132, thereby initiating an auction for the particular email hash.

At block 460, method 400 receives a response to the bid requests from advertisers 130 and 132. In response to the bid request, advertiser interface 208 may receive response to the bid requests including prices the advertisers 130 and 132 are willing to pay for the email hash, how may email hashes they wish to purchase, the period for which they wish to purchase the email hash, etc. The prices may be defined on a cost per mille (CPM) basis, calculated using a click-through rate, a conversional goal, or some other metric.

At block 470, method 400 performs yield optimization based on the responses to determine a combination of creatives for the ad slots that will maximize a payout to the publisher 140 for the advertisement template. In one embodiment, yield optimizer 210 performs a yield optimization based on the responses to the bid requests to determine creatives 248 for each of the ad slots in the template that will maximize a payout to the publisher 140 for the template. In one embodiment, the yield may be affected by such factors as the price an advertiser is willing to pay, how many ad slots an advertiser is willing to purchase, how many email hashes the advertiser is willing to reserve, how many advertisers are willing to purchase a given slot or reserve a given email hash, the basis on which the cost is defined, the period of time for which the advertiser is willing to purchase the ad slot or other factors. Yield optimizer 210 may perform calculations based on these factors and store the results as yield optimization data 246.

At block 480, method 300 serves the determined creatives for the ad slots. Based on the yield optimization, user agent interface 206 may select creatives 248 provided by advertisers 130 and 132 and serve those creatives 248 to user agent 112 to be displayed in the designated ad slots of the template 242 associated with the piece of content 142 provided by publisher 140.

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a user device, such as user device 110, or of a server, such as server 120, running ad slot ownership module 124.

The exemplary computer system 500 includes a processing device 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-readable storage medium 528, on which is stored one or more set of instructions 522 (e.g., software) embodying any one or more of the methodologies of functions described herein. The instructions 522 may also reside, completely or at least partially, within the main memory 504 and/or within the processing device 502 during execution thereof by the computer system 500; the main memory 504 and the processing device 502 also constituting machine-readable storage media. The instructions 522 may further be transmitted or received over a network 520 via the network interface device 508.

The machine-readable storage medium 528 may also be used to store instructions to perform a method for ad slot ownership processing, as described herein. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

In one example ad slot ownership processing flow, documents and markup language are designed and resources and variations are designed to optimize in order to delight end users as well as meet certain business goals such as selling a product, increasing brad awareness, etc., loaded in the system and assigned to a collection of resources (e.g., an advertising campaign). A document may be created with markup language, and a collection of resources may be created (e.g., a campaign) with associated resources (e.g., creatives). The target and rules for the document, markup language and collections of resources are configured in the system. The document may be deployed through multiple devices and servers. Once the end user requests the document, he or she receives the document with the markup language. The markup language points to the collections of resources on the system and requests a collection of resources from the system. The system may apply the rules set for the document and collection of resources, choosing the best resource available at the time, and locking the decision for the collection of resources that was chosen. Resource variation may be decisioned based on the conditions of the end user. On re-request by the user for a document, the collection of resources previously decisioned stays the same, and the best resource available is chosen until the collection of resources has ended.

In another example ad slot ownership processing flow, a publisher defines the number of ad slots on a page, which can be any number of ad slots (e.g., 1, 2, 20 . . . ) and the publisher places code for each ad slot in the appropriate place within their code for the page. The publisher loads or edits their template within their content management system or email service provider and sends the email via their email service provider. A subscriber to the publisher opens the email newsletter on any device and enables images. When images are enabled the ad calls will be sent to the system. When the system receives the first ad call, the system will check to see if this email had been previously opened with images enabled or if this is the first time the email has been opened. If the email has not been previously opened, then bid requests will be sent to demand partners including real time bidding partners, direct publisher sales and house ads. The system may then receive bid responses and values from any party participating in the auction. The auction is generally run on a cost per mille basis, but could be calculated utilizing a click-through rate or conversion goal or any goal defined by a marketer. The winning advertiser may be based on maximizing the payout to the publisher. The advertiser will then own the ad slot for a period of time. If the email has previously been opened and it is within the period of time then the same advertiser still owns the impression. The advertiser may serve the same creative that was originally served or the advertiser may change the creative. The system may check to see if creative is still valid. If creative has not changed, the same creative will be viewed when someone re-opens the email. If the offer is no longer valid, the advertiser can serve in a new more relevant offer when the email is reopened. The advertiser may be able to change the offer/creative for the user, but may not be able to change the landing page to which the creative is directed. After the reserved period of time the advertiser no longer owns the ad slot and the ad slot will be put up for auction again. In one embodiment, the system does not need to charge the advertiser for multiple impressions of one or more creatives (e.g., when the user reopens the same email multiple times). Since the ad slot is owned or reserved by the advertiser for a period of time, they need only pay a set price for that period, regardless of how many times one or more targeted creatives are viewed by the user within the period.

Absent the techniques described herein, existing offerings have no way of monetizing multiple impressions aside from charging the advertiser each time the email with a creative is reopened by the user.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the media server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the web server or media server.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method for a server computer system comprising:
receiving, from a user agent, a call requesting a creative for a first slot of a plurality of slots, wherein the first slot is part of a template associated with a content item, the template to define a layout of the plurality of slots;
determining, by a processing device, whether an ownership period associated with the first slot has expired;
when the ownership period associated with the first slot has not expired, selecting, in view of rules and constraints associated with the first slot, a creative from a campaign associated with an advertiser that owns the first slot for the ownership period; and
serving, to the user agent, the selected creative for the first slot.

2. The method of claim 1, further comprising:
determining whether the template associated with the content item has been previously accessed by at least one of the user agent or another user agent.

3. The method of claim 1, wherein the ownership period associated with the first slot defines a period of time during which the advertiser that owns the first slot has an exclusive right to present creatives in the first slot.

4. The method of claim 1, wherein selecting the creative from the campaign associated with the advertiser comprises performing a business result optimization for a plurality of creatives from the campaign to determine the creative that will optimize at least one of a click-through-rate or a number of conversions.

5. The method of claim 2, further comprising, when the template has not been previously accessed:
generating a bid request for the first slot;
receiving, from one or more bidders, responses to the bid request, the responses comprising a price for the first slot and an associated period of time;
performing a yield optimization based on the responses to the bid request to determine an advertiser and ownership period for the slot that maximizes a payout or value for the slot;
determining the creative to be served based on optimizing the success rate during the ownership period; and
serving, to the user agent, the determined creative for the first slot.

6. The method of claim 1, wherein the content item comprises at least one of an email, a webpage, a social media program or a mobile application.

7. The method of claim 1, wherein the template comprises an advertisement template.

8. A system comprising:
a memory; and
a processing device operatively coupled to the memory, the processing device to:
receive, from a user agent, a call requesting a creative for a first slot of a plurality of slots, wherein the first slot is part of a template associated with a content item, the template to define a layout of the plurality of slots;
determine whether an ownership period associated with the first slot has expired;
when the ownership period associated with the first slot has not expired, select, in view of rules and constraints associated with the first slot, a creative from a campaign associated with an advertiser that owns the first slot for the ownership period; and
serve, to the user agent, the selected creative for the first slot.

9. The system of claim 8, wherein the processing device is further to:
determine whether the template associated with the content item has been previously accessed by at least one of the user agent or another user agent.

10. The system of claim 8, wherein the ownership period associated with the first slot defines a period of time during which the advertiser that owns the first slot has an exclusive right to present creatives in the first slot.

11. The system of claim 8, wherein to select the creative from the campaign associated with the advertiser, the processing device to perform a business result optimization for a plurality of creatives from the campaign to determine the creative that will optimize at least one of a click-through-rate or a number of conversions.

12. The system of claim 9, when the template has not been previously accessed, the processing device further to:
generate a bid request for the first slot;
receive, from one or more bidders, responses to the bid request, the responses comprising a price for the first slot and an associated period of time;
perform a yield optimization based on the responses to the bid request to determine an advertiser and ownership period for the slot that maximizes a payout or value for the slot;
determine the creative to be served based on optimizing the success rate during the ownership period; and
serve, to the user agent, the determined creative for the first slot.

13. The system of claim 8, wherein the content item comprises at least one of an email, a webpage, a social media program or a mobile application.

14. The system of claim 8, wherein the template comprises an advertisement template.

15. A non-transitory computer-readable storage medium storing instructions which, when executed, cause a processing device to perform operations comprising:
receiving, from a user agent, a call requesting a creative for a first slot of a plurality of slots, wherein the first slot is part of a template associated with a content item, the template to define a layout of the plurality of slots;
determining, by the processing device, whether an ownership period associated with the first slot has expired;
when the ownership period associated with the first slot has not expired, selecting, in view of rules and constraints associated with the first slot, a creative from a campaign associated with an advertiser that owns the first slot for the ownership period; and
serving, to the user agent, the selected creative for the first slot.

16. The non-transitory computer-readable storage medium of claim 15, wherein the operations further comprise:
determining whether the template associated with the content item has been previously accessed by at least one of the user agent or another user agent.

17. The non-transitory computer-readable storage medium of claim 15, wherein the ownership period associated with the first slot defines a period of time during which the advertiser that owns the first slot has an exclusive right to present creatives in the first slot.

18. The non-transitory computer-readable storage medium of claim 15, wherein selecting the creative from the campaign associated with the advertiser comprises performing a business result optimization for a plurality of creatives from the campaign to determine the creative that will optimize at least one of a click-through-rate or a number of conversions.

19. The non-transitory computer-readable storage medium of claim 16, further comprising, when the template has not been previously accessed:
generating a bid request for the first slot;
receiving, from one or more bidders, responses to the bid request, the responses comprising a price for the first slot and an associated period of time;
performing a yield optimization based on the responses to the bid request to determine an advertiser and ownership period for the slot that maximizes a payout or value for the slot;
determining the creative to be served based on optimizing the success rate during the ownership period; and
serving, to the user agent, the determined creative for the first slot.

20. The non-transitory computer-readable storage medium of claim 15, wherein the content item comprises at least one of an email, a webpage, a social media program or a mobile application.
